(19) United States
(12) Patent Application Publication
(10) Pub. No.: US 2010/0258230 A1
(43) Pub. Date: Oct. 14, 2010

(54) METHOD FOR MANUFACTURING TYRES FOR VEHICLES WHEELS

(76) Inventors: Marco Cantu, Milano (IT); Maurizio Marchini, Milano (IT); Cesare Emanuele Amurri, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/743,793

(22) PCT Filed: Nov. 28, 2007
(86) PCT No.: PCT/IB07/03809

§ 371 Date: May 19, 2010

(51) Int. Cl. B60C 5/00; B29D 30/08

(52) U.S. Cl. 152/450; 156/123

(57) ABSTRACT

A method of manufacturing a tyre for vehicle wheels, includes the following steps: a) building a carcass structure; b) building a belt structure; c) building a tread band; wherein at least one of the carcass structure, belt structure and tread band includes a tubular structure of elastomeric material; and d) shaping the carcass structure into a toroidal conformation to associate it with at least said belt structure by exerting a radial deformation force directed from the inside to the outside of the carcass structure. The method includes the following step, during execution of at least one of steps a), b) and c): e) building the tubular structure in such a manner that the profile thereof, along its circumferential extension, has such a starting thickness that the deformed tubular structure following step d) has a substantially uniform thickness.

The invention relates to a method of manufacturing tyres for vehicle wheels and to a tyre manufactured by said method.

In more detail, the invention applies to the manufacture of tubular structures designed to define some tyre components.

Preferably, such components can be selected from liner, under-liner, tread band, under-layer of the tread band, under-layer of the belt structure, at least one sidewall portion.

A tyre for vehicles generally comprises a carcass structure provided with at least one carcass ply having respectively opposite end flaps in engagement with respective annular anchoring structures, integrated into the regions usually identified as “beads”, which have an inner diameter substantially corresponding to a so-called “fitting diameter” of the tyre on a respective mounting rim.

Associated with the carcass structure is a belt structure comprising one or more belt layers, located in radially superposed relationship with respect to each other and to the carcass ply.

Each belt layer can have textile or metallic reinforcing cords with a crossed orientation and/or substantially parallel to the circumferential extension direction of the tyre (zero-degree layer).

A tread band is applied at a radially external position to the belt structure, said tread band too being made of elastomeric material like other semifinished products constituting the tyre.

Respective sidewalls of elastomeric material are also applied at an axially external position, onto the side surfaces of the carcass structure, each extending from one of the side edges of the tread band until close to the respective annular anchoring structure to the beads.

In tyres of the “tubeless” type, an airtight coating layer of elastomeric material, usually referred to as “liner”, covers the radially internal surfaces of the tyre, another layer of elastomeric material as well, and usually referred to as “under-liner” generally overlapping said liner at a radially external position.

Within the present specification and the following claims, by the term “elastomeric material” it is intended a compound comprising at least one elastomeric polymer and at least one reinforcing filler. Preferably, this compound further comprises additives such as cross-linking agents and/or plasticizers. Due to the presence of the cross-linking agents, this 2-5 material can be cross-linked by heating, so as to form the final article of manufacture.

In traditional processes for tyre manufacture, the carcass structure and belt structure together with the respective tread band are provided to be made separately from each other by assembly of semifinished components in respective work stations, to be then mutually assembled at a second time, as described in document U.S. Pat. No. 3,990,931 for example.

In relatively recent times, production processes have been developed which are such conceived as to avoid production and storage of semifinished products. For instance, in document WO 01/36185 in the name of the same Applicant, a robotized arm carries a toroidal support on which each of the components of a tyre under production is directly made. The robotized arm gives the toroidal support a circumferential-distribution motion around the geometric axis thereof, simultaneously with controlled transverse-distribution displacements in front of a delivery member supplying a continuous elongated element of elastomeric material. The continuous elongated element therefore forms a plurality of coils the orientation and mutual-overlapping parameters of which are such managed as to control the thickness variations to be given to a component of a tyre being manufactured, based on a predetermined laying scheme preset on an electronic computer.

The Applicant has noticed that in processes of the type shown in U.S. Pat. No. 3,990,931, the carcass structure, belt structure and tread band can be manufactured around respective drums of substantially cylindrical conformation and generally comprise one or more tubular structures of elastomeric material such as liner, under-liner of the carcass structure, under-layer of the belt structure, at least one sidewall portion, under-layer of the tread band and the tread band itself, as it is a tubular structure of elastomeric material too.

In addition, the Applicant has observed that in particular one or more of said tubular structures can be made by laying a continuous elongated element of elastomeric material around a forming drum during the so-called “spiralling” step, as disclosed in WO 01/36185.

The Applicant has also noticed that in building processes like the one disclosed in U.S. Pat. No. 3,990,931, the assembling step between carcass structure, belt structure and tread band takes place by an outwardly-directed radial stressing action, through inflation for example, so as to obtain, in addition to assembly, the toroidal profile of the built green tyre (“shaping” step).

The Applicant has also noticed that, following said stressing action, the axially external portions of the carcass structure, i.e. the closest portions to the axial ends of the carcass structure, are substantially only submitted to a rotation-translation action, while the axially internal portions of the carcass structure are submitted to an important circumferential deformation due to the geometric modification imposed by the shaping step that mainly results in an increase in the diameter of the carcass structure itself.

The Applicant therefore, after completion of the shaping step, could find a lack of homogeneity in, the thickness of the deformed carcass structure, that could be estimated by observing a section in a radial plane of the carcass structure itself.

In particular, the axially internal portions have a smaller thickness than the axially external portions being the closest to the axial ends of the carcass structure.

FIGS. 3a and 3b diagrammatically show what has been hitherto described: FIG. 3a diagrammatically shows the section of a half of a tubular structure 100 having a substantially constant starting thickness Y; FIG. 3b is again a section view of the same half of the tubular structure 100 after the shaping step, in which lack of homogeneity in the thickness Y1, Y2 of the deformed structure is highlighted.

The Applicant has noticed that this deformation phenomenon can be of importance as regards said carcass structure, with particular reference to the previously described tubular structures such as liner and under-liner.

The Applicant has also noticed that, although to a smaller degree, the lack of homogeneity in thickness is also present in the belt structure and tread band; in the last-mentioned cases the deformation is of less amount due to the fact that the shape of the belt structure and tread band before the shaping step is not too different from that they take at the end of said shaping step, which means that the deformation to which they are submitted is smaller than that experienced by the carcass structure.

The Applicant has also found that said lack of homogeneity appearing in the thickness of said tubular structures, with particular reference to the tubular structures that can be present in the carcass structure such as liner and under-liner, can cause serious drawbacks both during the shaping step where tearing and/or micropunctures at the portions of lower thickness may occur, and subsequently with reference to the quality and performance of the tyre during use. The Applicant has finally verified that this phenomenon can be more apparent where said tubular structures are built by winding and superposition of coils of a continuous elongated element on a forming drum.

The Applicant has perceived that, in order to avoid this lack of homogeneity, the thickness variation of each tubular structure can be determined a priori, according to suitable mathematical models, and can be also compensated for by making a tubular structure with an imposed variable thickness.

In more detail, in accordance with the invention, the Applicant has found that, after determining the deformations to which the tubular structure will have to be submitted, it is possible to calculate the profile that the thickness of the tubular structure must have in order that, following the shaping step, a deformed structure with a substantially even thickness is obtained, after defining the profile thickness that the tubular structure must have before the deformation resulting from the shaping step, manufacture of the tubular structure having such a profile is started.

In particular, according to one aspect, the present invention relates to a method of manufacturing tyres for vehicle wheels, said method comprising the following steps:

a) building a carcass structure;
b) building a belt structure;
c) building a tread band;
wherein at least one of the carcass structure, belt structure and tread band comprises a tubular structure of elastomeric material;
d) shaping said carcass structure into a toroidal conformation to associate it with at least said belt structure by exerting a radial deformation force directed from the inside to the outside of said carcass structure;
said method comprising the following step, during execution of at least one of steps a), b) and c):
e) building said tubular structure in such a manner that the profile thereof, along its circumferential extension, has such an starting thickness that the deformed tubular structure following step d) has a thickness showing a variation included between about 0.01% and about 12%.

According to a further aspect, the present invention relates to a tyre manufactured following the above described method.

In the tyre thus manufactured one or more tubular structures are present that have a profile the thickness of which is compatible with the design specifications, without unevennesses that can lead to discard the tyre or to a reduction in the tyre performance.

The present invention, in at least one of the above mentioned aspects, can have at least one of the following preferred features.

According to a preferred embodiment, said thickness has a variation included between about 0.01% and about 5%.

More preferably, said thickness has a variation included between about 0.01% and about 2%.

Preferably, said profile is of such a nature that the tubular structure, prior to the shaping step of the carcass structure, has a thickness at its axially external ends, smaller than the thickness of an axially internal portion thereof.

As above discussed, in fact, the axially internal portion of the tubular structure is the one submitted to deformations, and in particular to thickness reductions, of greater extent; thus, by increasing the starting thickness of said axially internal portion, a substantially constant thickness is obtained after carrying out the shaping step on the carcass structure.

Preferably, the above mentioned tubular structure is a liner belonging to said carcass structure.

Preferably, the above mentioned tubular structure is an under-liner belonging to said carcass structure.

Preferably, the above mentioned tubular structure is an under-layer of the belt structure.

Preferably, the above mentioned tubular structure is at least one sidewall portion.

Preferably, the above mentioned tubular structure is an under-layer of the tread band.

Preferably, the above mentioned tubular structure is the tread band.

Preferably, the tubular structure is manufactured by laying a continuous elongated element of elastomeric material on a substantially cylindrical forming drum, which elongated element defines a succession of coils around said drum.

More preferably, said starting thickness therefore can be obtained by varying the mutual overlapping of said coils along the axial extension of the tubular structure.

In addition or as an alternative, this thickness can be obtained by varying along the axial extension of the tubular structure, the tension with which the continuous elongated element is laid on the forming drum.

According to a preferred embodiment, the starting thickness is determined as a function of the starting radius of said undeformed tubular structure and of a radius of said deformed tubular structure, following said shaping step:

Preferably, said starting thickness is determined as a function of a difference in the absolute value between a starting radius of said tubular structure, estimated at a starting volume element being part of said tubular structure, and a radius of said deformed structure, estimated at a deformed volume element obtained from deformation of said starting volume element.

Alternatively, said starting thickness is determined as a function of a ratio of a starting radius of said tubular structure estimated at a starting volume element being part of said tubular structure, to a radius of said deformed structure, estimated at a deformed volume element obtained from deformation of said starting volume element.

More preferably, said starting thickness is determined according to the relation:

$${S}_{1} = {S}_{2} \cdot \frac{R 2}{R 1}$$

wherein:
S₁ is the thickness of the undeformed volume element;
S₂ is the thickness of the deformed volume element;
R1 is the starting radius of the undeformed tubular structure estimated at the undeformed volume element;
R2 is the radius of the deformed tubular structure estimated at the deformed volume element.

Alternatively, said starting thickness is determined according to the relation:

$${S}_{1} = {S}_{2} \cdot \sqrt{\frac{R 2}{R 1}}$$

wherein:
S₁ is the thickness of the undeformed volume element;
S₂ is the thickness of the deformed volume element;
R1 is the starting radius of the undeformed tubular structure estimated at the undeformed volume element;
R2 is the radius of the deformed tubular structure estimated at the deformed volume element.

According to a preferred embodiment, said step c) takes place following said step b) by directly building said tread band over said belt structure.

Alternatively, said step c) takes place after said step d) by directly building said tread band over said belt structure having a toroidal conformation and already associated with said carcass structure.

Preferably, in said step d) said carcass structure by taking a toroidal conformation is associated with the belt structure-tread band assembly.

Further features and advantages will become more apparent from the detailed description of a preferred but not exclusive embodiment of a method of manufacturing tyres for vehicle wheels in accordance with the present invention.

This description will be set out hereinafter with reference to the accompanying drawings, given by way of non-limiting example, in which:

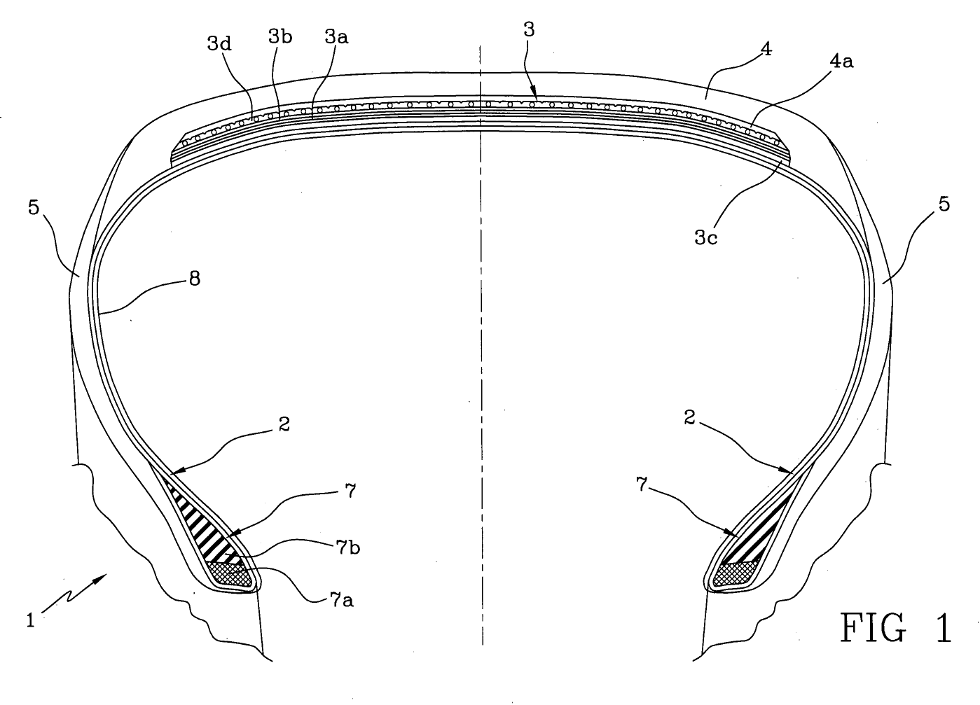

FIG. 1 shows a tyre manufactured with the method in accordance with the present invention;

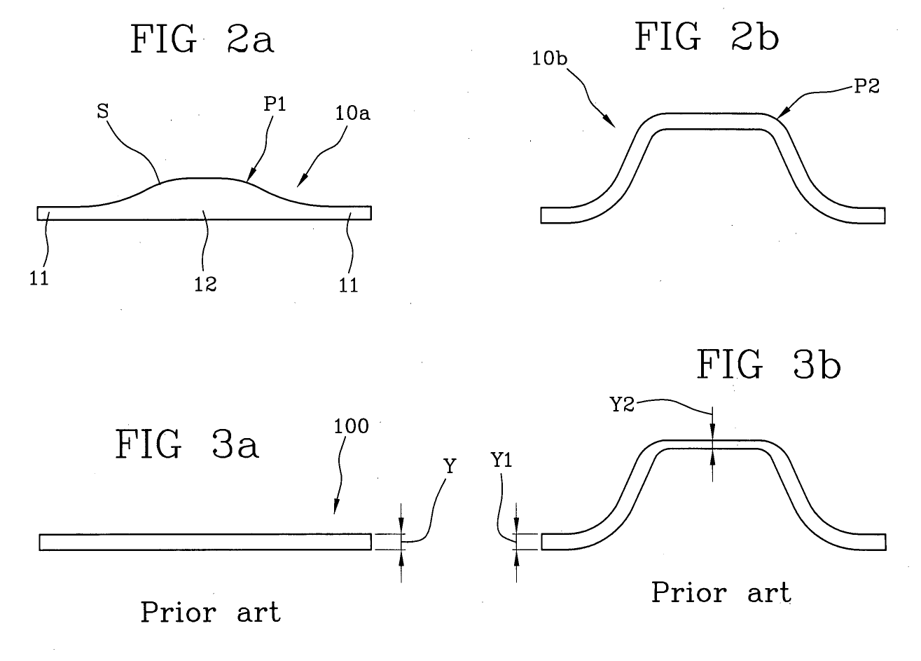

FIGS. 2a and 2b show a section view in a radial plane of part of a tubular structure used in the method of the invention, before and after the step of shaping the carcass structure, respectively;

FIGS. 3a and 3b show a section view in a radial plane of part of, a tubular structure in accordance with the known art, before and after the step of shaping the carcass structure, respectively;

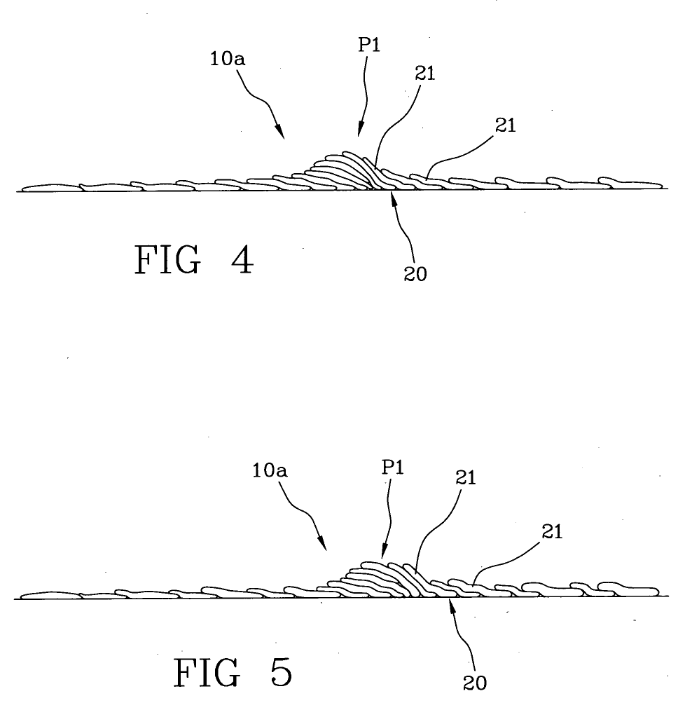

FIG. 4 diagrammatically shows a first embodiment for the tubular structure in FIG. 2a;

FIG. 5 diagrammatically shows a second embodiment for the tubular structure in FIG. 2a;

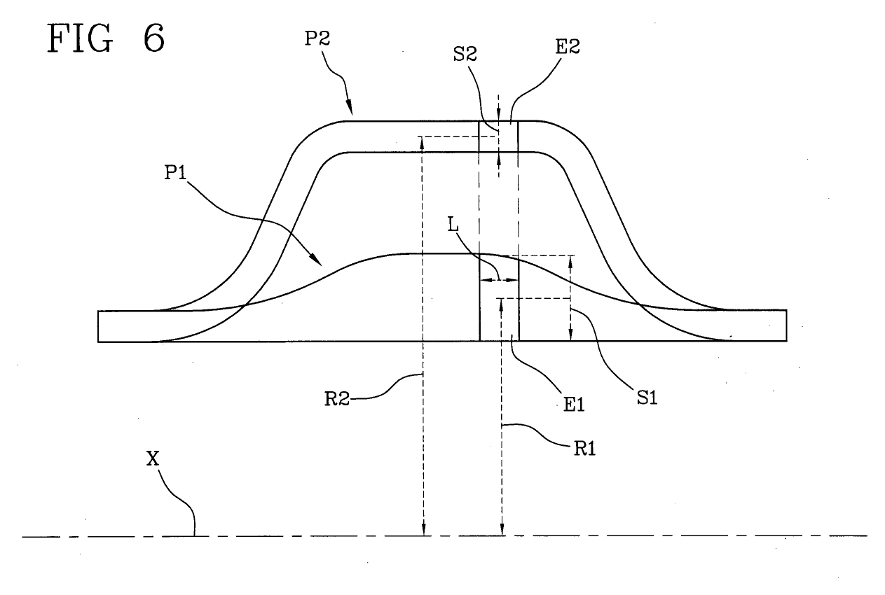

FIG. 6 diagrammatically and simultaneously reproduces FIGS. 2a and 2b, highlighting therein some calculation quantities used in the method of the invention.

With reference to the cited drawings, a tyre for vehicle wheels obtained by adopting the method in accordance with the invention has been generally identified with reference numeral 1.

Tyre 1 (FIG. 1) comprises a carcass structure 2 formed of one or more carcass plies having the respective opposite end flaps in engagement with annular reinforcing structures 7 integrated into circumferential regions internal to tyre 1, usually identified with the name of “beads”.

Each annular reinforcing structure 7 comprises one or more substantially inextensible annular inserts 7a and one or more filling inserts 7b coupled to the carcass plies.

At a radially external position to the carcass structure 2, a belt structure 3 is applied and it comprises one or more belt layers 3a, 3b having respectively crossed reinforcing cords, and a possible auxiliary belt layer 3d comprising one or more generally rubberised cords made of textile or metallic Material, spirally wound up around the geometric axis of tyre 1.

Interposed between the carcass structure 2 and said belt layers 3a, 3b is an under-layer of the belt structure 3c, made of elastomeric material.

Tyre 1 further comprises a tread band 4 applied at a radially external position to the belt structure 3; an under-layer 4a of the tread band made of elastomeric material can be applied between the belt structure 3 and tread band 4.

Preferably tyre 1 further comprises a pair of abrasion-proof inserts (not shown) that are each externally applied close to one of the tyre beads 7, and a pair of sidewalls 5 each of which covers the carcass structure 3 at a laterally external position.

The carcass structure 2 can be internally coated with a so-called “liner” 8, i.e. a thin layer of elastomeric material that, when vulcanisation is over, will be airtight so as to ensure maintenance of the inflation pressure of tyre 1 in use.

A so-called under-liner of elastomeric material can be further interposed between liner 8 and the carcass plies. The method in accordance with the invention comprises the steps of building a carcass structure 2, building a belt structure 3, and building a tread band 4; said carcass structure 2, belt structure 3 and tread band 4 are then mutually associated in order to obtain tyre 1. It will be appreciated that sidewalls 5′ can be built during building of the carcass structure 2, during building of the tread band 4, or partly during building of the carcass structure 2 and partly during building of the tread band 4.

In more detail, at least one of the carcass structure 2, belt structure 3 and tread band 4 may comprise a tubular structure 10a of elastomeric material.

Preferably, the tubular structure 10a is a liner 8 belonging to said carcass structure 2, an under-liner belonging to said carcass structure 2, or an under-layer 3c of the belt structure 3, at least one sidewall portion belonging to the carcass structure 2 or to the tread band 4, an under-layer 4a of the tread band 4, or the tread band 4 itself.

The Applicant has found that particularly advantageous results in applying the method being the object of the present invention are obtained where said tubular structure 10a is part of the carcass structure 2, and in particular where it constitutes liner 8 and/or the under-liner.

The method further comprises a step of shaping the carcass structure 2 into a toroidal conformation to associate it with at least the belt structure 3 by exerting a radial deformation force directed from the inside to the outside of the carcass structure 2 itself.

Preferably, the radial deformation force can be obtained by inflation of the carcass structure 2.

By this shaping step, therefore, the dual result is obtained of mutually engaging the carcass structure 2 and belt structure 3 and of giving the semifinished product thus obtained the toroidal shape that tyre 1 must take.

In order to obtain, following the shaping step, a deformed structure having a substantially even thickness in a section taken in a radial plane of the tubular structure, the method of the invention comprises a step of determining, before building of said tubular structure 10a, a suitable profile P1 of the tubular structure 10a itself, defined by a respective starting thickness S.

Determination of this profile P1 can be carried out by acting, by way of example, in the following manner, with reference to FIG. 6 diagrammatically showing, in a section view taken in a radial plane, the profiles of the same half of the tubular structure before and after the step of shaping the carcass structure 2.

Denoted at 10a in FIG. 2′ is the undeformed starting tubular structure, while identified with reference numeral 10b is the deformed structure resulting from the step of shaping the carcass structure 2.

The profile P2 defined after the shaping step, as above discussed, is substantially uniform, i.e. it has thickness variations included between about 0.01% and about 12%.

More preferably, said thickness variations are included between about 0.01% and about 5%.

Most preferably, said thickness variations are included between about 0.01% and about 2%.

In the following specification and in the appended claims these variations are referred to the average thickness of the profile along the axial size thereof, calculated as (“maximum thickness”+“minimum thickness)/2.

The profile P1 defined before the shaping step, on the contrary, has an imposed variable course along axis X.

Both profiles P1, P2 are divided into elementary blocks or elements; this division is quite theoretical/virtual and is exclusively aimed at the following considerations and calculations and does not represent the true structure of the two profiles.

For the sake of clarity, reference will be made hereinafter to a single volume element E1 of the starting profile P1, and to the corresponding volume element E2 of the deformed profile P2.

Let us assume that the volume element E2 is submitted to a deformation in a radial direction alone, and not in an axial direction, said axial direction being defined by axis X (FIG. 6).

The length L of the two volume elements E1, E2 measured along axis X of the tubular structure therefore can be very similar; the radial thickness S1, S2 of the two elements E1, E2 is on the contrary different.

Thickness S2 of the deformed volume element E2 is known a priori, while the unknown quantity is thickness S1 of the starting volume element E1.

In more detail, the two thicknesses S1, S2 are a function of the respective radii R1, R2 defining the distance between the geometric centres of gravity of the volume elements E1, E2 and axis X of the tubular structure 10a, 10b.

Also following the deformations to which they are submitted in the shaping step, the two volume elements E1, E2 cannot have different volumes, due to known physical laws of mass conservation.

By imposing the equality between the two volumes, it is therefore possible to determine thickness S1 of the starting and undeformed volume element E1.

Due to the above, the starting thickness of profile P1 of the tubular structure 10a can be determined as a function of the following quantities: thickness of the profile of the deformed structure, radius of the deformed structure and starting radius of the undeformed structure.

In more detail, with reference to the radius of the deformed tubular structure and the starting radius of the undeformed structure, the starting thickness can be determined as a function of a difference or a ratio between the same.

Referring to a single volume element before and after the shaping step, there is considered the starting radius R1 of the tubular structure 10a estimated at a starting volume element E1 being part of the tubular structure 10a itself, and the radius R2 of the deformed tubular structure 10b, estimated at the deformed volume element E2 obtained from deformation of said starting volume element E1.

Therefore, the starting thickness S1 can be calculated according to the relation:

$${S}_{1} = {S}_{2} \cdot \frac{R 2}{R 1}$$

wherein:
S₁ is the thickness of the undeformed volume element E1;
S₂ is the thickness of the deformed volume element E2;
R1 is the starting radius of the undeformed tubular structure 10a estimated at the volume element E1;
R2 is the radius of the deformed tubular structure 10b estimated at the deformed volume element E2.

By adopting a slightly different approach, it is possible to assume that each volume element of the tubular structure 10a is submitted to a non negligible deformation also along the axial direction X of the tubular structure 10a itself.

Following a reasoning similar to the above one, and assuming that each volume element is submitted to deformations of the same amount in an axial direction and in a radial direction, the following relation is obtained:

$${S}_{1} = {S}_{2} \cdot \sqrt{\frac{R 2}{R 1}}$$

wherein the quantities have the same meaning as above specified.

Thus if the above considerations are extended to all the volume elements constituting the tubular structure 10a, 10b before and after the step of shaping the carcass structure 2, the course of the thickness of the starting profile P1 of the tubular structure 10a along the axial direction X of same is determined.

Preferably, profile P1 has such a starting thickness that the tubular structure 10a, prior to the shaping step, at its axially external ends 11 has a smaller thickness than the thickness of an axially internal portion 12 thereof (FIGS. 2a, 2b).

In fact, the axially innermost portion 12 is the one submitted to the greatest deformation in terms of reduction in its thickness, and is therefore the one that must initially have a greater thickness.

In the preferred embodiment, the building step of the tubular structure 10a comprises a sub-step of laying a continuous elongated element 20 of elastomeric material on a forming drum of a substantially cylindrical conformation, said elongated element defining a succession of coils 21 around said drum.

In other words, during a so-called “spiralling” step, the continuous elongated element 20 is progressively wound up externally of the forming drum, the latter having a substantially cylindrical conformation.

In this manner, a succession of coils 21 around the drum is defined, so as to form the tubular structure 10a (FIGS. 4, 5).

The starting thickness of profile P1 of the tubular structure 10a can be defined by controlling the laying step in different ways.

For instance, the starting thickness can be obtained by varying the mutual overlapping of coils 21, along the axial extension of the tubular structure 10a. This means that, where a greater thickness is required, several coils 21 will be at least partly radially superposed, while where a smaller thickness is required, a smaller number of radially superposed coils 21 will be used (FIG. 4).

In addition or as an alternative to the above, the starting thickness of profile P1 of the tubular structure 10a can be obtained by varying a tension with which the continuous elongated element 20 is laid on the forming drum, along the axial extension of the tubular structure itself.

In fact, by increasing the tension with which the elongated element 20 is laid on the forming drum, the cross section area (i.e. evaluated in a plane orthogonal to the major longitudinal extension of the elongated element 20) of the elongated element is correspondingly decreased, thereby obtaining a reduction in the thickness of the respective coil 21 (FIG. 5).

Therefore, in the portion/portions of the tubular structure 10a where a smaller thickness is required, it will be necessary to increase the tension with which the elongated element 20 is laid down, while in the portion/portions where a greater thickness is required, the laying tension is to be reduced.

As above mentioned, the techniques for thickness control can be also used in combination with each other, so as to determine the starting thickness of profile P1 of the tubular structure 10a both through overlapping of coils 21 defined by the elongated element 20, and through a more or less marked tensioning of the elongated element 20 when laid down during the spiralling step.

In a different preferred embodiment, the tubular structure 10a is not made through laying of a elongated element on a forming drum, but through a calendering step, carried out by means of suitable rollers (not shown), by which step a sheet of elastomeric material having a thickness equal to said starting thickness of the profile of the tubular structure is directly obtained; then by closing said sheet and mutually engaging two opposite edges of same, a tubular structure having the desired profile is obtained.

Preferably, the step of building the tread band 4 takes place after the step of building the carcass structure 3, the thread band 4 being directly built on the belt structure 3 at a radially external position relative to the latter.

In a preferred embodiment, the step of building the tread band 4 takes place after the step of shaping the carcass structure 2, by directly building the tread band 4 over the belt structure 3 shaped into a toroidal conformation and already associated with said carcass structure 2.

In an alternative embodiment, the tread band 4 and belt structure 3 are mutually associated before the step of shaping the carcass structure 2; subsequently, during the step of shaping the carcass structure 2, the latter is associated with the assembly made up of the belt structure 3 and tread band 4.

In fact, the carcass structure 2, when submitted to the shaping step, increases its radial size and, in this manner, defines a constraint with the inner surface of the belt structure 3 that is in a radially external position relative to the carcass structure 2 itself.

1-22. (canceled)

23. A method of manufacturing a tyre for a vehicle wheel, comprising the following steps:
a) building a carcass structure;
b) building a belt structure;
c) building a tread band,
wherein at least one of the carcass structure, belt structure and tread band comprises a tubular structure of elastomeric material
d) shaping said carcass structure into a toroidal conformation to associate said carcass structure with at least said belt structure by exerting a radial deformation force directed from the inside to the outside of said carcass structure; and
during execution of at least one of steps a), b) and c):
e) building said tubular structure in such a manner that the profile thereof, along its circumferential extension, has a starting thickness such that the deformed tubular structure following step d) has a thickness showing a variation between 0.01% and about 12%.

24. The method as claimed in claim 23, wherein said thickness has a variation between about 0.01% and about 5%

25. The method as claimed in claim 23, wherein said thickness has a variation between about 0.01% and about 2%.

26. The method as claimed in claim 23, wherein said starting thickness of said profile is of a nature such that the tubular structure, prior to step d), has a thickness at axially external ends thereof, that is smaller than the thickness of an axially internal portion thereof.

27. The method as claimed in claim 23, wherein said tubular structure is a liner of said carcass structure.

28. The method as claimed in claim 23, wherein said tubular structure is an under-liner of said carcass structure.

29. The method as claimed in claim 23, wherein said tubular structure is an under-layer of the belt structure.

30. The method as claimed in claim 23, wherein said tubular structure is an under-layer of the tread band.

31. The method as claimed in claim 23, wherein said tubular structure is the tread band.

32. The method as claimed in claim 23, wherein said tubular structure is at least one portion of a sidewall.

33. The method as claimed in claim 23, wherein step e) comprises a sub-step of laying a continuous elongated element of elastomeric material on a substantially cylindrical forming drum, said elongated element comprising succession of coils around said drum.

34. The method as claimed in claim 33, wherein said starting thickness is obtained by varying the mutual overlapping of said coils along an axial extension of the tubular structure.

35. The method as claimed in claim 33, wherein said starting thickness is obtained by varying along an axial extension of the tubular structure, a tension with which said continuous elongated element is laid on said forming drum.

36. The method as claimed in claim 23, wherein said starting thickness is determined as a function of a starting radius of an un-deformed tubular structure and of a radius of said deformed tubular structure, following said shaping step.

37. The method as claimed in claim 36, wherein said starting thickness is determined as a function of a difference in an absolute value between a starting radius of said tubular structure, estimated at a starting volume element being part of said tubular structure, and a radius of said deformed structure, estimated at a deformed volume element obtained from deformation of said starting volume element.

38. The method as claimed in claim 36, wherein said starting thickness is determined as a function of a ratio of a starting radius (R1) of said tubular structure estimated at a starting volume element (E1) being part of said tubular structure, to a radius of said deformed structure, estimated at a deformed volume element (E2) obtained from deformation of said starting volume element.

39. The method as claimed in claim 38, wherein said starting thickness is determined according to the relation:
S₁=S₂·R2/R1
wherein:
S₁ is a thickness of the un-deformed volume element (E1);
S₂ is a thickness of the deformed volume element (E2);
R1 is the starting radius of the un-deformed tubular structure estimated at the un-deformed volume element (E1); and
R2 is the radius of the deformed tubular structure estimated at the deformed volume element (E2).

40. The method as claimed in claim 38, wherein said starting thickness is determined according to the relation:
S₁=S₂·\sqrt{R2/R1}
wherein:
S₁ is a thickness of the un-deformed volume element (E1);
S₂ is a thickness of the deformed volume element (E2);
R1 is the starting radius of the un-deformed tubular structure estimated at the un-deformed volume element (E1); and
R2 is the radius of the deformed tubular structure estimated at the deformed volume element (E2).

41. The method as claimed in claim 23, wherein step c) takes place following step b) by directly building said tread band over said belt structure.

42. The method as claimed in claim 23, wherein step c) takes place after step d) by directly building said tread band over said belt structure having a toroidal conformation and already associated with said carcass structure.

43. The method as claimed in claim 41, wherein, in step d), said carcass structure, by taking a toroidal conformation, is associated with a belt structure-tread band assembly.

44. A tyre manufactured by the method as claimed in claim 23.
